(19) United States
(12) Patent Application Publication
(10) Pub. No.: US 2014/0300567 A1
(43) Pub. Date: Oct. 9, 2014

(54) ELECTRONIC APPARATUS

(71) Applicant: Panasonic Corporation, Osaka (JP)

(72) Inventors: Masahiro INATA, Hyogo (JP); Yusuke ADACHI, Osaka (JP); Akira KOGA, Osaka (JP); Ryo OKUMURA, Osaka (JP)

(21) Appl. No.: 14/308,123

(22) Filed: Jun. 18, 2014

Related U.S. Application Data
(63) Continuation of application No. PCT/JP2013/000258, filed on Jan. 21, 2013.

(30) Foreign Application Priority Data
Jan. 24, 2012 (JP) 2012-011887

(51) Int. Cl. G06F 3/01; G06F 3/041

(52) U.S. Cl. CPC G06F 3/016; G06F 3/041
USPC 345/173

(57) ABSTRACT

An electronic device 100 includes: a touch panel 130 to be touched by a user; a panel vibrating section 140 for vibrating the touch panel 130; a tactile control section 33 for controlling the panel vibrating section 140; a display section 160 for presenting reference information indicating a reference timing with which the user is to make a touch operation on the touch panel 130; and a microcomputer 20 for detecting an amount of deviation between an input timing of the user's touch operation on the touch panel 130 and the reference timing. Based on the detected amount of deviation, the tactile control section 33 varies the vibration of the touch panel 130 to give the user a tactile sensation through the vibration.

This is a continuation of International Application No. PCT/JP2013/000258, with an international filing date of Jan. 21, 2013, which claims priority of Japanese Patent Application No. 2012-011887, filed on Jan. 24, 2012, the contents of which are hereby incorporated by reference.

### BACKGROUND

1. Technical Field

The present disclosure relates to an electronic device which generates vibrations in response to a touch operation by a user.

2. Description of the Related Art

In electronic devices having a touch panel disposed on a display screen, there are known techniques for giving a tactile sensation to the user by vibrating the touch panel, thus providing improved controllability for the user.

For example, Japanese Laid-Open Patent Publication No. 2008-181365 discloses a mobile device having vibration elements attached on the housing.

In an example disclosed in Japanese Laid-Open Patent Publication No. 2006-340744 where a touch panel is applied to a game machine, a touch panel is operated in accordance with the timing of videos or sounds, and videos and sounds are also used to express whether the timing of operation is good or bad.

In Japanese Laid-Open Patent Publication No. 2002-263365, a vibration motor is mounted on a controller for a game machine, the vibration motor generating vibrations by rotating an eccentric weight which is attached on a rotation axis of the motor. Enhanced realism is provided by vibrating the controller body based on information which is fed back from the game machine itself.

### SUMMARY

The present disclosure provides an electronic device that attains a novel, intuitive operation feel which, when a touch panel is operated in accordance with the timing of videos and/or sounds, presents various tactile sensations from the touch panel touched by the user, the tactile sensations being presented in accordance with the timing of operation.

An electronic device according to an embodiment of the present disclosure includes: a touch panel to be touched by a user; a vibrating section for vibrating the touch panel; a vibration control section for controlling the vibrating section; a presentation section for presenting reference information indicating a reference timing with which the user is to make a touch operation on the touch panel; and a detection section for detecting an amount of deviation between an input timing of a touch operation made by the user on the touch panel and the reference timing. Based on the detected amount of deviation, the vibration control section varies the vibration of the touch panel to give the user a tactile sensation through the vibration.

With an electronic device according to an embodiment of the present disclosure, a reaction made by the electronic device in response to an timing of operation by a user can be directly felt through a finger or the like touching the touch panel, whereby a novel, intuitive operation feel is provided.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIGS. 1A and 1B are perspective views showing the overall structure of an electronic device according to an embodiment.

FIG. 2 is an exploded perspective view of an electronic device according to an embodiment.

FIG. 3 is a cross-sectional view of an electronic device according to an embodiment.

FIG. 4 is a block diagram of an electronic device according to an embodiment.

FIG. 5 is a perspective view of a panel vibrating section according to an embodiment.

FIG. 6A and FIG. 6B are schematic illustrations each showing an example vibration pattern of a panel vibrating section according to an embodiment.

FIG. 7A is a schematic illustration showing an example driving waveform and an example vibration waveform of a vibration motor, and FIG. 7B is a schematic illustration showing an example vibration waveform of a panel vibrating section.

FIG. 8 is a flowchart showing a process of tactile sensation presentation by an electronic device according to an embodiment.

FIG. 9 is a schematic diagram for describing an amount of deviation between a reference timing and an input timing according to an embodiment.

FIG. 10 is a schematic diagram showing an example touch operation according to an embodiment.

FIG. 11 is a schematic diagram showing an example touch operation according to an embodiment.

FIG. 12 is a schematic diagram showing an example touch operation according to an embodiment.

FIG. 13 is a schematic diagram showing an example touch operation according to an embodiment.

FIG. 14 is a perspective view showing the external appearance of a vibration motor.

### DETAILED DESCRIPTION

Embodiments will now be described in detail, referring to the drawings. Note however that unnecessarily detailed descriptions may be omitted. For example, detailed descriptions on what is well known in the art or redundant descriptions on what is substantially the same constitution may be omitted. This is to avoid lengthy description, and facilitate the understanding of those skilled in the art.

The accompanying drawings and the following description, which are provided by the present inventors so that those skilled in the art can sufficiently understand the present disclosure, are not intended to limit the scope of claims.

In the game machine disclosed in Japanese Laid-Open Patent Publication No. 2006-340744, supra, the user operates the touch panel in accordance with a timing which is expressed by videos and sounds. However, videos and sounds are also employed when the game machine presents information in response to the operation timing, thus not promoting the actual operation feel. The game machine controller disclosed in Japanese Laid-Open Patent Publication No. 2002-263365, supra, is a controller which is operated by a user who holds the controller in both hands at a position away from a television set on which the game is being displayed. Therefore, even if a touch panel were provided on the display surface of the television set, vibration of the game machine controller would not play any part in the touch operation of the touch panel.

With an electronic device according to an embodiment, a reaction made by the electronic device in response to an timing of operation by a user can be directly felt through a finger or the like touching the touch panel, whereby a novel, intuitive operation feel is provided. Hereinafter, the electronic device according to an embodiment will be described in detail.

### Overall Structure of the Electronic Device

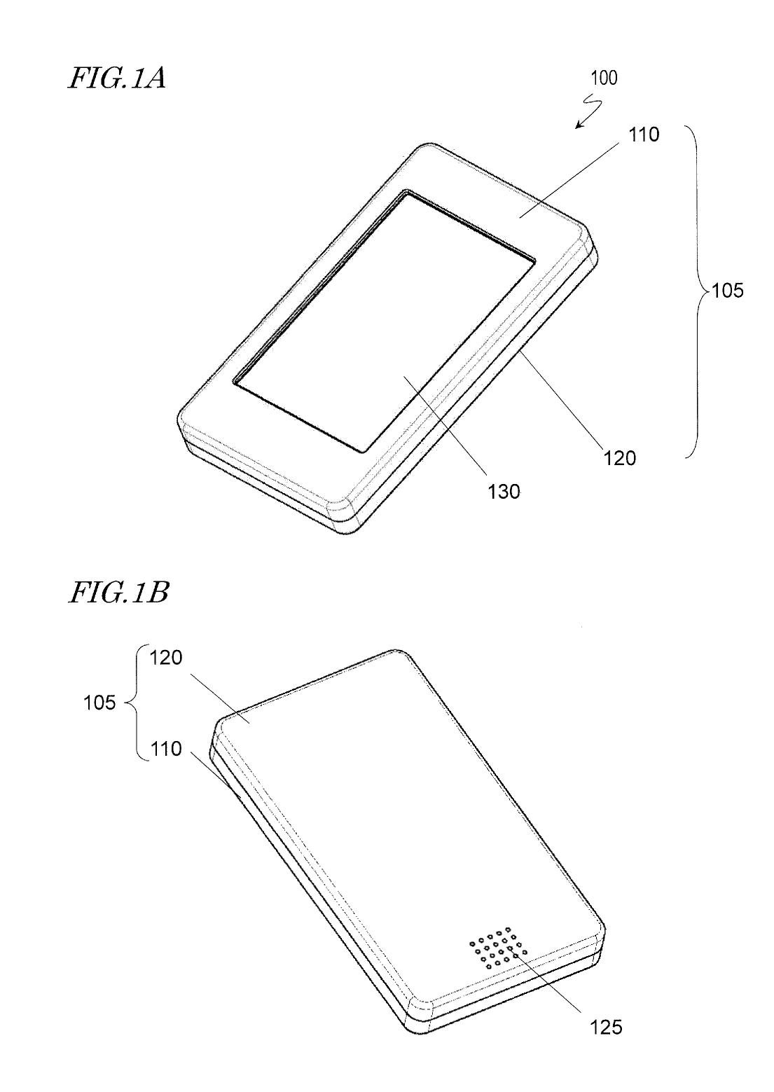

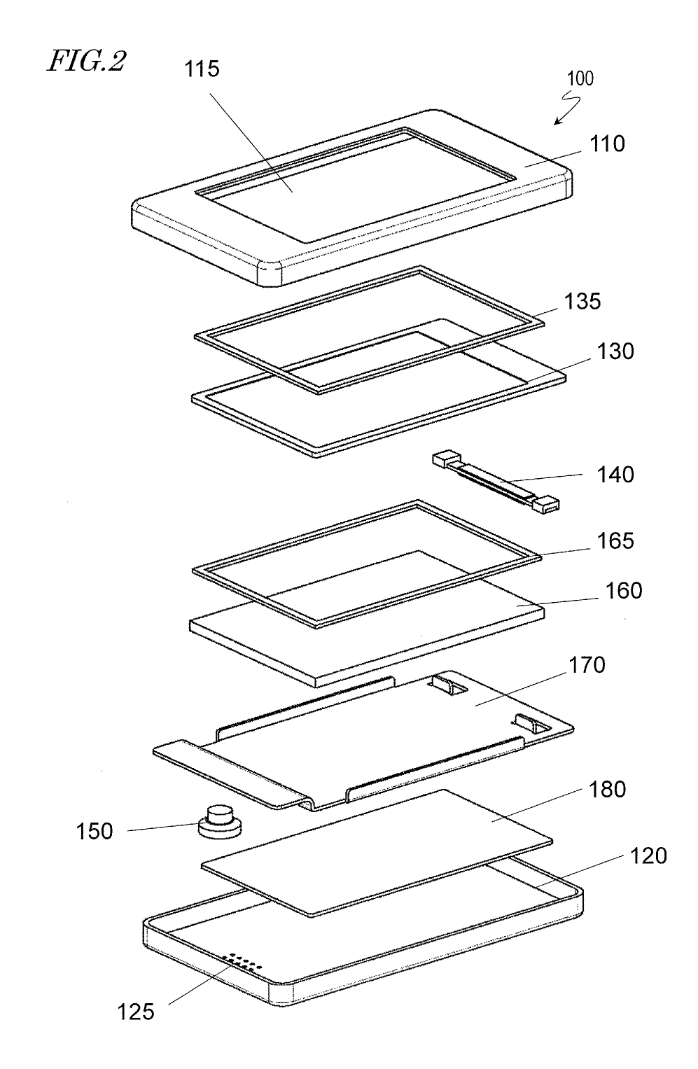

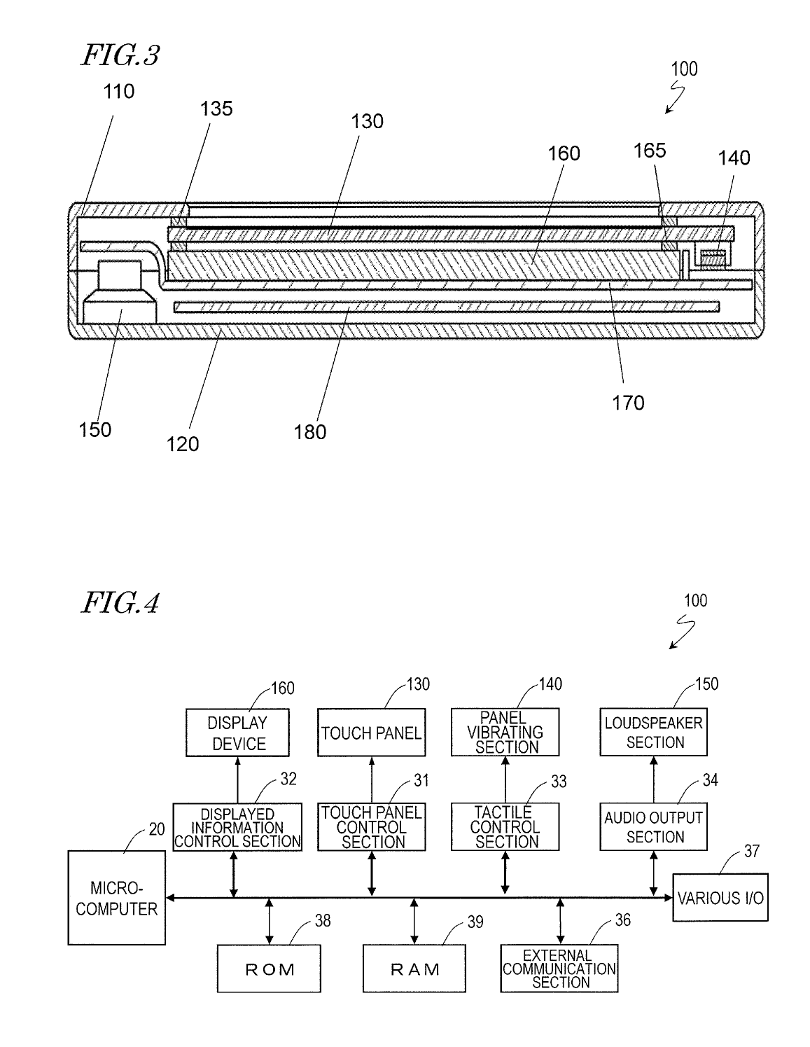

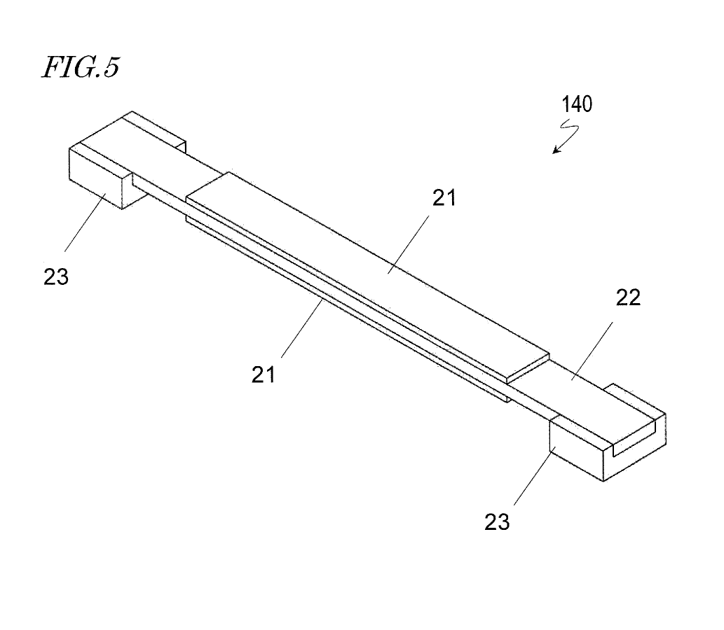

With reference to FIG. 1A to FIG. 4, the overall structure of an electronic device according to an embodiment will be described. FIG. 1 is a perspective view showing the overall structure of the electronic device according to an embodiment. FIG. 2 is an exploded perspective view of the electronic device according to an embodiment. FIG. 3 is a cross-sectional view of the electronic device according to an embodiment. FIG. 4 is a block diagram of the electronic device according to an embodiment.

As shown in FIG. 1A to FIG. 3, the electronic device 100 includes a display section 160, a touch panel 130 disposed so as to cover the display section 160, a panel vibrating section 140 for vibrating the touch panel 130, and a loudspeaker section 150 for outputting audio. The touch panel 130 is an example of a panel member to be touched by the user. The touch panel 130 is provided at the display surface side of the display section 160, on which an image is to be displayed. The display section 160 is an example of a presentation section that presents reference information indicating a reference timing with which the user needs to perform a touch operation on the touch panel 130.

The user operates the electronic device 100 by touching the touch panel 130 over a content that is displayed by the display section 160, using a finger, a pen, or the like.

An upper housing 110 and a lower housing 120 are integrally coupled with screws or the like, thereby constituting a housing 105 of the electronic device 100. A display window 115 is made in the upper housing 110, thus allowing the touch panel 130 to be operated through the display window 115. A meshed portion 125 is made in the lower housing 120 so as not to obstruct any audio that is output from the loudspeaker section 150.

The panel vibrating section 140 is attached on the touch panel 130. By driving the panel vibrating section 140, the touch panel 130 can be vibrated. Thus, when the user operates the touch panel 130, a tactile sensation in the form of vibration is given to the user.

Moreover, in order to prevent the vibration of the touch panel 130 from being directly transmitted to the upper housing 110, a cushion member 135 is provided between the upper housing 110 and the surface of the touch panel 130.

The display section 160 is disposed on a face of the touch panel 130 opposite from the face oriented toward the upper housing 110, and similarly to the aforementioned, a cushion member 165 is provided so as to prevent the vibration of the touch panel 130 from being directly transmitted to the display section 160. The cushion members 135 and 165 are, for example, shock-absorbing members such as silicone rubber or urethane rubber.

An image which is displayed on the display section 160 can be visually recognized via the touch panel 130, through the display window 115.

The display section 160 is attached on a frame 170 which is fixed to the lower housing 120, and is fixed inside the electronic device 100.

The loudspeaker section 150 is attached on the lower housing 120. The audio which is output from the loudspeaker section 150 propagates to the exterior of the housing 105 through the meshed portion 125.

A circuit board 180 is attached to the lower housing 120. The touch panel 130, the display section 160, the panel vibrating section 140, and the loudspeaker section 150 are electrically connected to the circuit board 180. The touch panel 130, the display section 160, the panel vibrating section 140, and the loudspeaker section 150 are controlled by a microcomputer 20 which is provided on the circuit board 180. The microcomputer 20 controls the overall operation of the electronic device 100. The microcomputer 20 performs operations such as detection and determination of various information, and controls the operation of each component element.

The touch panel 130 is a touch panel of an electrostatic type, a resistive type, an optical type, etc. The touch panels 130 detects a position of touch by the user. The touch panel 130 is controlled by the touch panel control section 31. The microcomputer 20 is able to obtain information of the touch position of the user via the touch panel control section 31.

The display section 160 is a display device of a liquid crystal type, an organic EL type, an electronic paper type, a plasma type, etc. The display section 160 is controlled by the displayed information control section 32. Via the displayed information control section 32, the microcomputer 20 is able to present any indication to the user on the display section 160.

Although the touch panel 130 and the display section 160 are separate elements in the present embodiment, the touch panel 130 and the display section 160 may be formed as an integral member. For example, an in-cell type touch panel may be employed where the touch panel function is integrated inside a liquid crystal panel; an on-cell type touch panel may be employed where the touch panel function is integrated on the surface of a liquid crystal panel; and so on. By using such approaches, a thinner profile and a lighter weight can be realized.

As shown in FIG. 4, the electronic device 100 of the present embodiment includes: the microcomputer 20; a ROM 38 for storing various programs; a RAM 39 for storing various data; the display section 160; the displayed information control section 32 for controlling the display section 160; the touch panel 130; the touch panel control section 31 for controlling the touch panel 130; a tactile control section 33 for controlling the panel vibrating section 140 to present a tactile sensation when the touch panel 130 is operated; an audio output section 34 for controlling the loudspeaker section 150 to reproduce an audio signal; an external communication section 36 for performing communications with the exterior; and a various I/O section 37 for performing various other input/output. By using a wireless LAN such as Wi-Fi (registered trademark), the external communication section 36 is connected under authentication of interconnection between a plurality of electronic devices. Connection between electronic devices may also be realized by: a method which provides connection via an external communications device, e.g., an access point; P2P (wireless ad hoc network) connection, which is a method of direct connection without utilizing an external communications device; or the like.

### Constitution of the Panel Vibrating Section

Next, the constitution of the panel vibrating section 140 will be described with reference to FIG. 5. FIG. 5 is a perspective view of the panel vibrating section 140 according to the present embodiment.

As shown in FIG. 5, the panel vibrating section 140 includes piezoelectric elements 21, a shim plate 22, and a base 23. The piezoelectric elements 21 are adhesively bonded on both sides of the shim plate 22. Each piezoelectric element 21 is, for example, a piezoelectric ceramic of lead zirconate titanate or the like, or a piezoelectric single crystal of lithium niobate or the like. Both ends of the shim plate 22 are attached to the base 23, thus resulting in a so-called double-supported constitution. The base 23 is attached to the touch panel 130. The piezoelectric elements 21 expand or contract with a driving voltage from the tactile control section (vibration control section) 33. By controlling the piezoelectric elements 21 attached on the opposite sides of the shim plate 22 so that one expands while the other contracts, the shim plate 22 flexes, which generates vibration when repeated in succession.

The shim plate 22 is a spring member of phosphor bronze or the like, for example. The vibration of the shim plate 22 vibrates the touch panel 130 via the base 23. The user operating the touch panel 130 can feel the vibration of the touch panel 130 through a touch operation of the touch panel 130.

The base 23 is a metal such as aluminum or brass, or a plastic such as PET or PP, for example.

The vibration frequency, amplitude, and vibration period when presenting a tactile sensation in response to an operation of the touch panel 130 is controlled by the tactile control section 33, and it becomes possible to present various tactile sensations to the user by changing at least one of these. For example, in accordance with an amount of deviation between an input timing of the user's touch operation on the touch panel 130 and a reference timing described later, and changes at least one of vibration frequency, amplitude, and vibration period. As the vibration frequency, frequencies from about 100 Hz to about 400 Hz, at which humans are most likely to feel tactile sensations, are desirable.

Note that while the piezoelectric elements 21 are attached to the shim plate 22 in the present embodiment, the piezoelectric elements 21 may be attached directly to the touch panel 130. Alternatively, a thin-film transparent piezoelectric member may be formed on the touch panel 130 by a method such as sputtering, and used as the panel vibrating section 140. Where a cover member, or the like, is present on the touch panel 130, the piezoelectric elements 21 may be attached to the cover member. Note that where a cover member is present on the touch panel 130, the touch panel 130 and the cover member are collectively referred to as a panel member for detecting a touch position.

Although the present embodiment illustrates a double-supported constitution in which both sides of the shim plate 22 are supported on the base 23, a cantilever constitution in which only one side of the shim plate 22 is supported on the base 23 may be adopted.

Although the present embodiment conveniently illustrates that the panel vibrating section 140 is proved on only one side of the touch panel 130, a plurality of vibrating sections may be provided on both sides or every side, etc.

### Description of an Input Signal to the Panel Vibrating Section

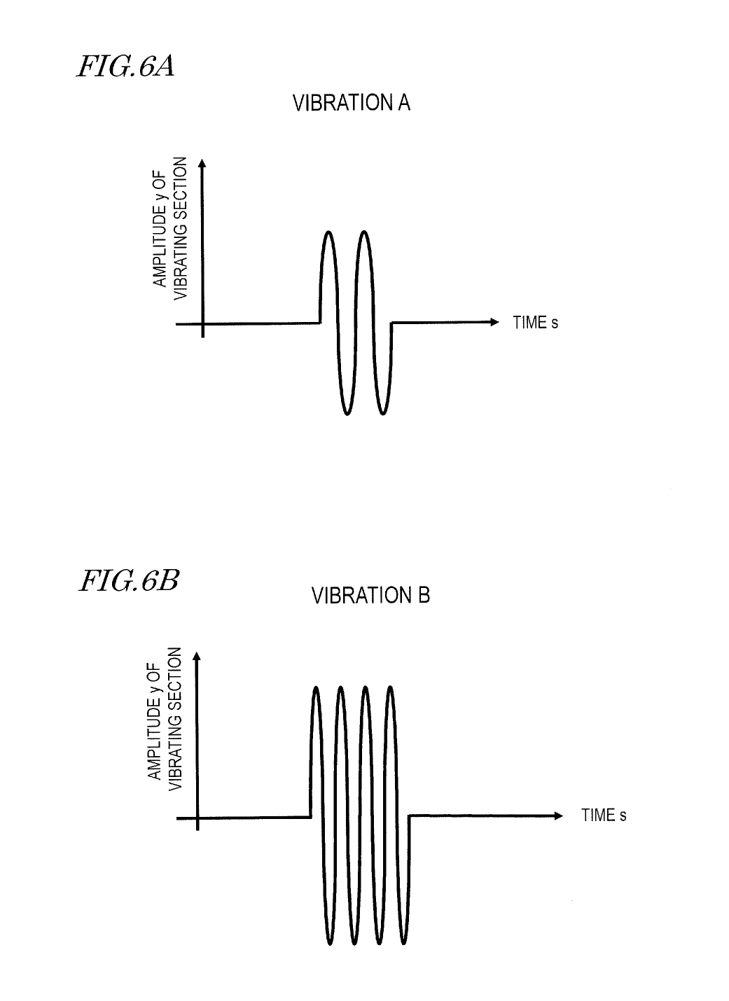

FIGS. 6A and 6B are schematic illustrations each showing an example vibration pattern of the panel vibrating section 140.

With an instruction from the microcomputer 20, the tactile control section 33 applies a voltage to the panel vibrating section 140 to vibrate the touch panel 130 with an amplitude shown in FIG. 6A, thus giving the user a vibration A. The voltage for generating vibration A is a sinusoidal wave of 150 Hz, 70 Vrms, 2 cycles, for example. The amplitude on the touch panel 130 in this case is about 5 μm. On the other hand, as the tactile control section 33 applies a voltage to the panel vibrating section 140 to vibrate the touch panel 130 with an amplitude shown in FIG. 68, thus giving the user a vibration B. The voltage for generating vibration B is a sinusoidal wave of 300 Hz, 100 Vrms, 4 cycles, for example. The amplitude on the touch panel 130 in this case is about 15 μm. Note that by setting the frequency and the voltage so that the amplitude on the touch panel 130 is about 5 to 50 μm, it is possible to present a tactile sensation (vibration) that feels comfortable on a human finger.

Note that the frequency, voltage, and cycle are exemplary. Other waveforms such as a rectangular wave or a sawtooth wave, an intermittent waveform, or a waveform whose frequency or amplitude changes continuously may be used. Moreover, the level of amplitude on the touch panel 130 is exemplary; the amplitude level will change under different conditions, such as the size of the touch panel 130, the supporting method, and the number of panel vibrating sections 140.

### Comparison Between Vibration of the Panel Vibrating Section 140 and Vibration of a Vibration Motor

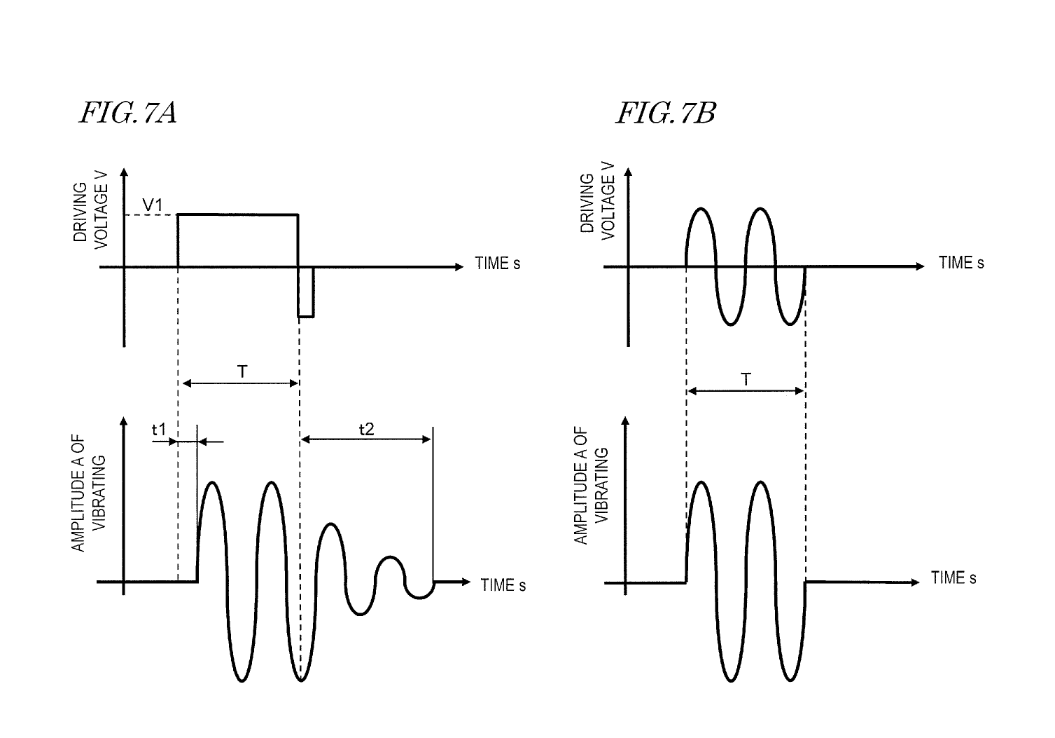

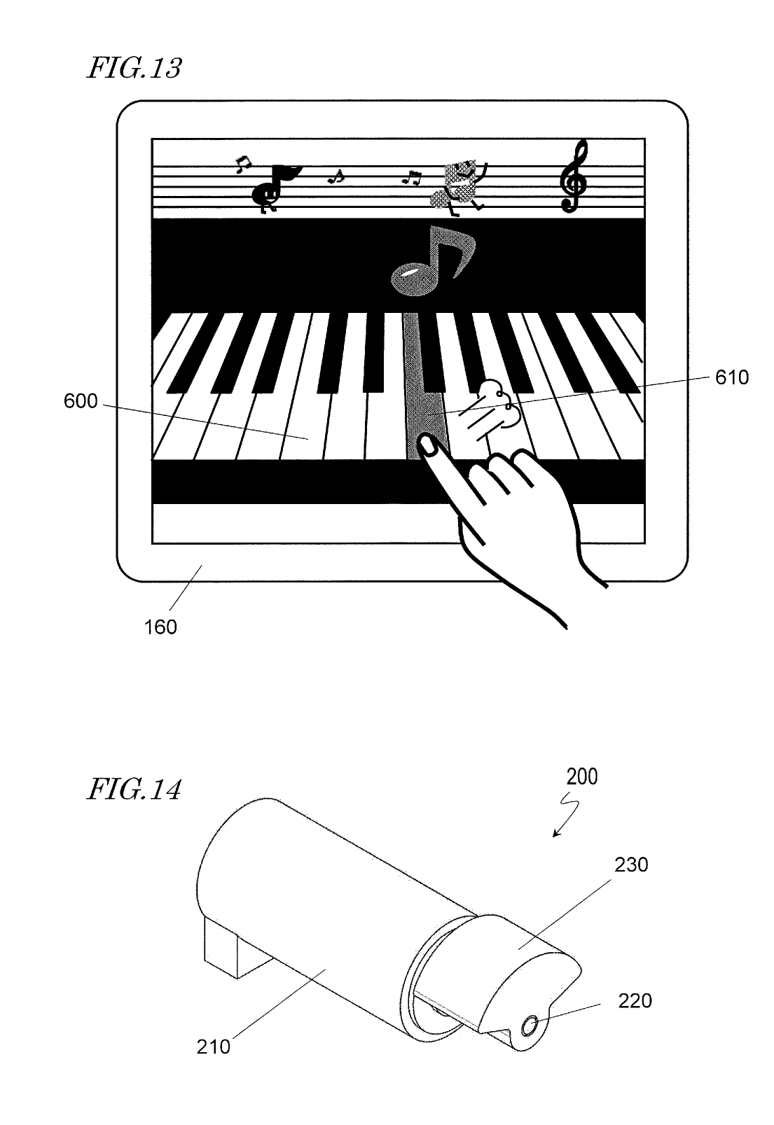

FIG. 7 shows a comparison between the vibration waveform of a vibration motor 200 shown in FIG. 14 and the vibration waveform of the panel vibrating section 140 according to the present embodiment. The vibration motor 200 shown in FIG. 14 generates vibration by rotating an eccentric weight 230 which is attached on a rotation axis 220 of a motor 210. FIG. 7A is a schematic illustration showing an example driving voltage and an example vibration waveform of the vibration motor 200. FIG. 7B is a schematic illustration showing an example driving voltage and an example vibration waveform of the panel vibrating section 140.

As shown in FIG. 7A, by applying a voltage V1 to the vibration motor 200 to rotate the motor 210, the eccentric weight 230 is rotated around the rotation axis 220, thereby generating vibration. When a time T has passed, in order to stop the rotation, an inverted voltage is applied for braking. When the eccentric weight 230 rotates or stops, inertia of the eccentric weight 230 affects the vibration waveform which is generated in response to the driving voltage in the following manners, as shown in FIG. 7A: when starting driving, a delay of time t1 occurs until the motor 210 rotates; and when stopping driving, a delay of time t2 occurs until the motor 210 completely stops.

On the other hand, as shown in FIG. 7B, the panel vibrating section 140 of the present embodiment generates vibration by utilizing expansion and contraction of the piezoelectric elements 21, thus being able to generate a vibration waveform which incurs hardly any delay when starting or stopping driving, without being affected by inertia as would the vibration motor 200 be.

Because rotation of the eccentric weight 230 is converted into vibration, the vibration which is obtained by using the vibration motor 200 is subject to limitations of revolutions that are associated with the characteristics of the motor 210, and thus vibration can be generated only up to about 100 Hz. However, as mentioned above, the frequencies at which humans are likely to feel tactile sensations are from about 100 Hz to about 400 Hz. Therefore, it is difficult for the vibration motor 200 to present vibrations in this frequency band. Furthermore, due to the influence of inertia of the eccentric weight 230, a delay of time t1 occurs when starting driving, and a delay of time t2 occurs when stopping driving, thus resulting in lingering vibration. Since this lingering vibration is transmitted to the user through the housing while the user is holding the device body, an oddness will emerge after each touch operation. Moreover, if quick consecutive touch operations are performed, e.g., a double click, such lingering vibration will still exist when the next vibration is presented, thus making it impossible to sufficiently present a tactile sensation which is adapted to each operation.

Therefore, according to the present embodiment, the vibrating section for the touch panel 130 is the panel vibrating section 140 featuring the piezoelectric elements 21 as its driving mechanism, thereby solving such problems of the vibration motor 200.

Note that the vibration waveform diagram of FIG. 7 is an explanatory schematic diagram, and the actual vibration response is not limited thereto. For example, although driving of the piezoelectric elements 21 is illustrated with respect to an example where there is no delay between the driving voltage and the vibration waveform, some delay may occur depending on the time constant of the driving circuit, the constitution of the vibrating section, or the like.

Moreover, there may be some lingering vibration after stopping driving depending on the resonant frequency of the touch panel 130.

### Tactile Sensation Presenting Process

When a user performs a touch operation on the touch panel 130 in accordance with a reference timing which is expressed by a video, a sound, or the like, the electronic device 100 according to an embodiment vibrates the touch panel 130 so that a tactile sensation from the touch panel 130 will indicate whether the input timing of the user's touch operation is good or bad.

The display section 160 displays reference information which indicates a reference timing with which a user is supposed to perform a touch operation on the touch panel 130. The microcomputer 20 detects an amount of deviation between the input timing of the user's touch operation on the touch panel 130 and the reference timing, and changes the vibration of the touch panel 130 based on the detected amount of deviation, thereby giving the user a different tactile sensation in accordance with the amount of deviation. For example, the vibration of the touch panel 130 may be varied depending on whether the amount of deviation is large or small, thus familiarizing the user with different tactile sensations until the user can recognize whether the touch timing is good or bad.

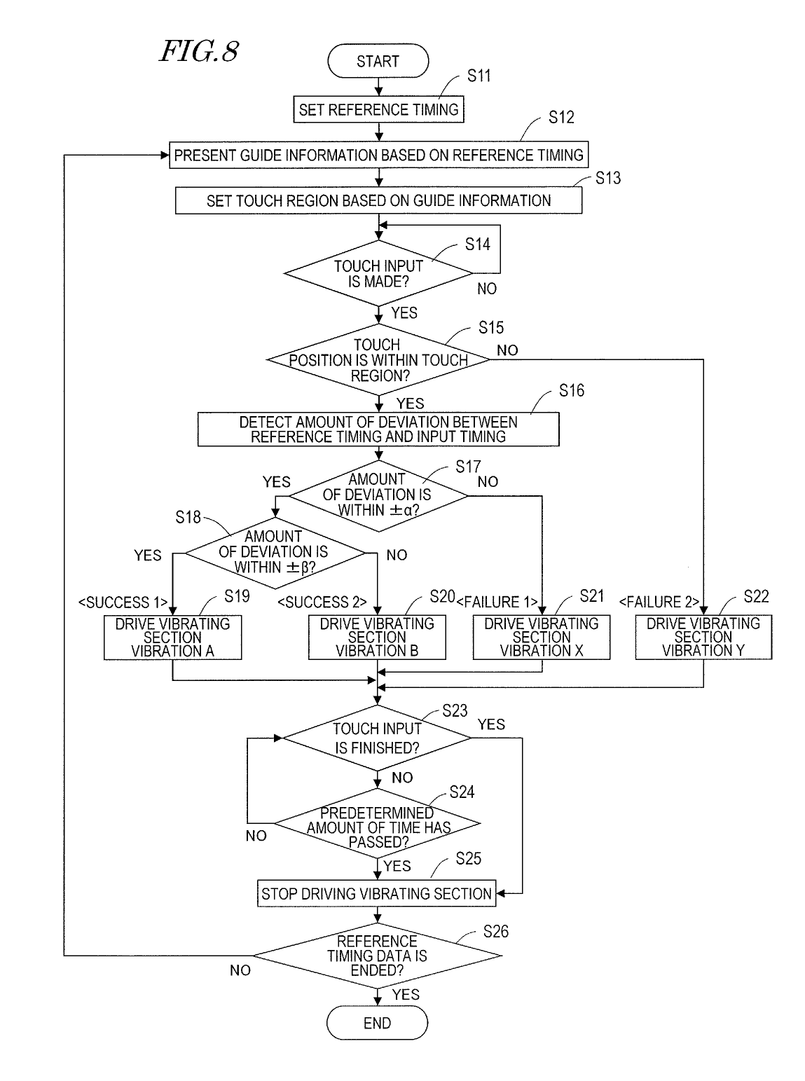

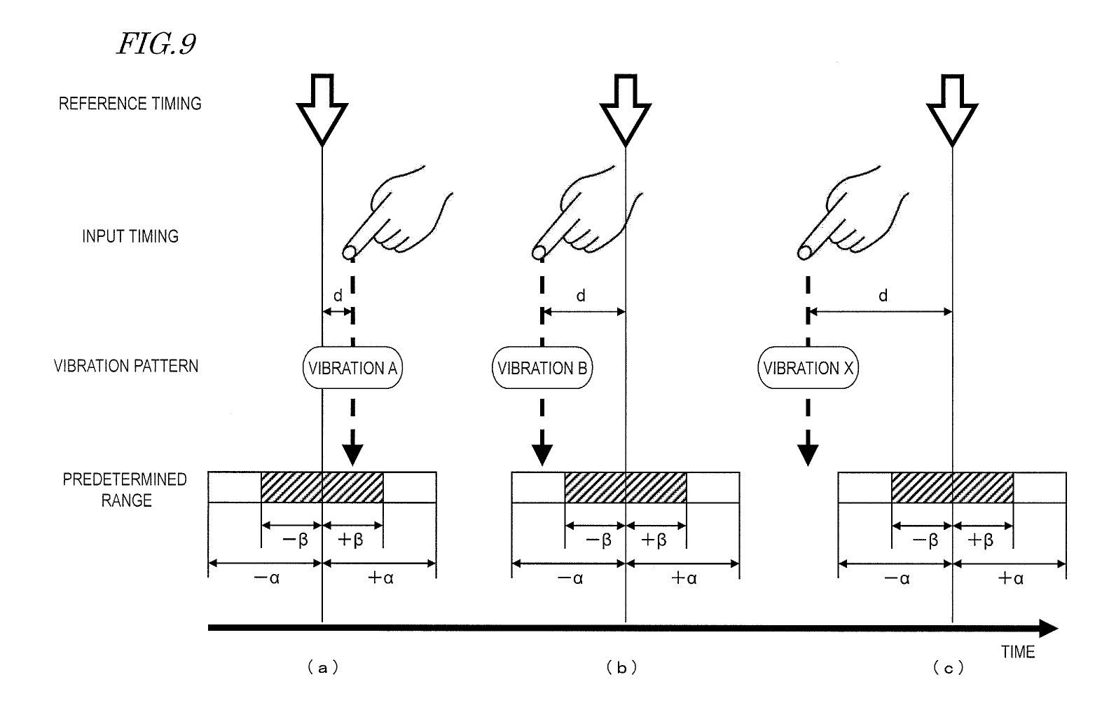

Hereinafter, as an example, a process of tactile sensation presentation in a game program in which the input timing of a user's touch operation is compared against a reference timing for evaluation will be described with reference to FIGS. 8 and 9.

FIG. 8 is a flowchart showing the process of tactile sensation presentation according to the present embodiment. In the flowchart, steps are abbreviated as S.

FIG. 9 is a schematic diagram for describing an amount of deviation between a reference timing and an input timing according to the present embodiment.

As shown in FIG. 8, the microcomputer 20 starts a game program which is stored in the ROM 38. This game program contains reference information. At S11, the game program sets a reference timing. At the next S12, in order to present this reference timing to the user, guide information is presented in the form of a video, a sound, or the like. For example, the reference information contains at least one of image information and sound information. If it is an image, it is presented by the display section 160; if it is a sound, it is presented by the sound loudspeaker section 150. The image may be a moving picture or a still picture. Then, the process proceeds to S13.

Next, at S13, a touch region in which a touch operation will be regarded valid is set based on the guide information presented at S12. The reference information further contains position information indicating a position on the display section 160 at which the touch region is to be displayed, so that the touch region will be displayed at a position corresponding to the position information. Details of the touch region will be described in exemplary operations of game programs described later. Then, the process proceeds to S14.

At S14, based on information from the touch panel control section 31, the microcomputer 20 determines whether the user has made a touch input to the touch panel 130 or not. If no touch has been made, a touch input is awaited. If S14 finds that a touch input “is made”, the process proceeds to S15. Note that, if no touch input is detected for a predetermined amount of time or longer at S14, the process may move to S26.

At S15, the amount of deviation between a position at which the user has touched the touch panel 130 and the position corresponding to the position information is detected. In this example, based on the information from the touch panel control section 31, the microcomputer 20 determines whether the touched position is within the touch region set at S13 or not. If the microcomputer 20 determines that the touch position is within the touch region, the process proceeds to S16.

At S16, the microcomputer 20 detects the amount of deviation between the reference timing and the input timing of the touch operation made to the touch panel 130. Specifically, as shown in FIG. 9, an amount of deviation d is detected, which is the difference between the reference timing and the input timing. The amount of deviation d is temporarily stored to the RAM 39, for example, and the process proceeds to S17.

At S17, the microcomputer 20 determines whether the amount of deviation d falls within a predetermined range of ±α from the reference timing, as shown in FIG. 9. The predetermined range ±α is a range within which a touch operation is regarded as “successful” in the game program, for example. If the microcomputer 20 determines that the amount of deviation d is ±a or less, the process proceeds to S18.

At S18, the microcomputer 20 determines whether the amount of deviation d falls within a predetermined range of ±β (β<α) from the reference timing, as shown in FIG. 9.

If the microcomputer 20 determines that the amount of deviation d is ±β or less, i.e., the input timing being as indicated in portion (a) of FIG. 9, the user's touch operation is determined as “Success 1”, and the process proceeds to S19.

At S19, the tactile control section 33 controls the panel vibrating section 140 to give the user a vibration A. By feeling vibration A through the finger touching the touch panel 130, the user recognizes that the finger has touched the touch panel 130, and confirms that the touch operation has turned out to be “Success 1”. After vibration A is presented, the process proceeds to S23.

On the other hand, if the microcomputer 20 determines that the amount of deviation d is greater than ±β at S18, i.e., the input timing being as indicated in portion (b) of FIG. 9, the user's touch operation is determined as “Success 2”. Since the predetermined range of ±β is narrower than the predetermined range of ±α, it is meant that “Success 2” matches more poorly with the reference timing than “Success 1”. For example, the game program may give a lower evaluation (score) for “Success 2” than “Success 1”. Then, the process proceeds to S20.

At S20, the tactile control section 33 controls the panel vibrating section 140 to give the user a vibration B which is distinct from vibration A. By feeling vibration B through the finger touching the touch panel 130, the user recognizes that the finger has touched the touch panel 130, and confirms that the touch operation has turned out to be “Success 2”. After vibration B is presented, the process proceeds to S23.

Moreover, if the microcomputer 20 determines that the amount of deviation d is greater than the predetermined range of ±α at S17, i.e., the input timing being as indicated in portion (c) of FIG. 9, the user's touch operation is determined as “Failure 1” because this falls outside the ranges in which the game program would recognize a “success”. Then, the process proceeds to S21.

At S21, the tactile control section 33 controls the panel vibrating section 140 to give the user a vibration X which is distinct from vibrations A and B indicating “successful”. By feeling vibration X through the finger touching the touch panel 130, the user recognizes that the touch operation has turned out to be “Failure 1”, via tactile sensation. The vibration pattern of vibration X may be one that does not drive the panel vibrating section 140 at all. After vibration X is presented, the process proceeds to S23.

If the microcomputer 20 determines at step S15 that the touched position falls outside the touch region set at S13 based on information from the touch panel control section 31, the operation is determined as “Failure 2” because this falls outside the ranges designated by the game program, and the process proceeds to S22.

At S22, the tactile control section 33 controls the panel vibrating section 140 to give the user a vibration Y which is distinct from vibrations A and B indicating “successful”. By feeling vibration Y through the finger touching the touch panel 130, the user recognizes that the touch operation has turned out to be “Failure 2”, via tactile sensation. Note that vibration Y may be the same vibration pattern as vibration X or different, or the vibration pattern of vibration Y may be one that does not drive the panel vibrating section 140 at all. After vibration Y is presented, the process proceeds to S23.

At S23, the microcomputer 20 determines whether the user's touch input on the touch panel 130 is finished or not, based on information from the touch panel control section 31. If the touch input is not finished, the process proceeds to S24.

At S24, the microcomputer 20 determines whether a predetermined amount of time has passed since a touch input is detected at S14. If the predetermined amount of time has not passed, the process returns to S23 to again determine whether the touch input is finished or not. If the predetermined amount of time has passed, the process proceeds to S25. On the other hand, it is determined at S23 that the touch input is finished, the process proceeds to S25.

At S25, the tactile control section 33 controls the panel vibrating section 140 to stop vibration, and the process proceeds to S26.

At S26, the microcomputer 20 determines whether the period for presenting the reference timing set by the game program at S11 is ended or not. If the period for presenting the reference timing is ended, the flow of the tactile sensation presentation is ended. If the period for presenting the reference timing is not ended, the process returns to S12 to again perform tactile sensation presentation based on a comparison between the reference timing and the input timing.

### Example Operations

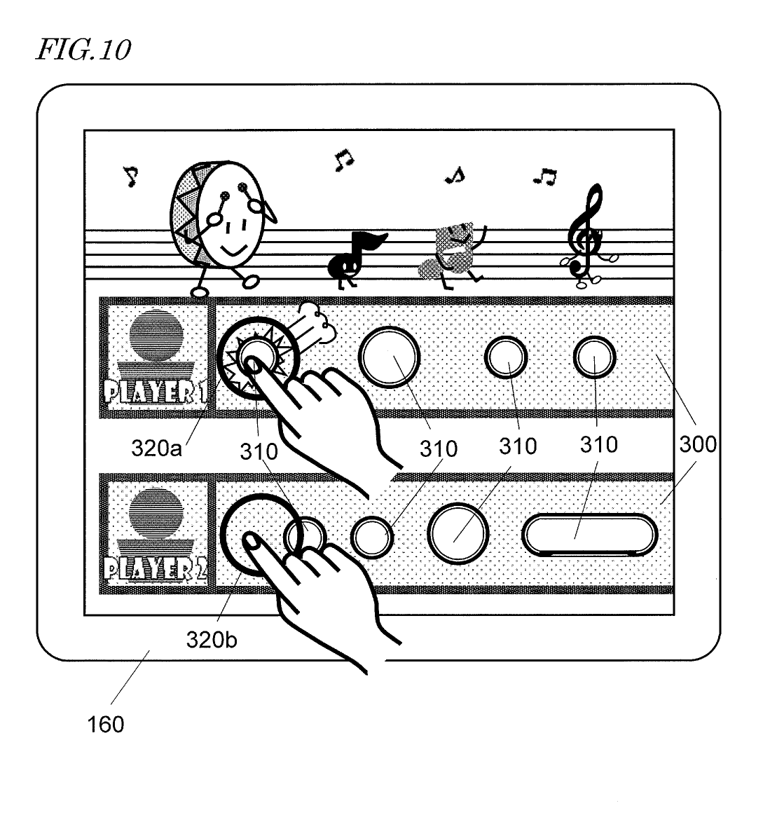

Next, with reference to FIG. 10 to FIG. 13, exemplary operations of game programs using the electronic device 100 according to an embodiment will be described.

FIG. 10 shows an example game program in which a touch operation is to be made in accordance with timing markers 310 which are displayed on the display section 160.

As shown in FIG. 10, displayed on the display section 160 are: marker displaying areas 300 (shown hatched); timing markers 310 moving in each marker displaying area 300 from the right end to the left end; and input accepting frames 320a and 320b. Each timing marker 310 is displayed as if moving at a constant velocity to a piece of music, for example.

The exemplary operation shown in FIG. 10 is that of a game program where one is supposed to make a touch input with the timing when a moving timing marker 310 arrives at (or overlaps) the input accepting frame 320a or 320b by the left end of each marker displaying area 300.

In this case, the timing with which a moving timing marker 310 overlaps the input accepting frame 320a or 320b defines the reference timing being presented to the user.

As illustrated in the upper row of FIG. 10, a success is detected when a touch is made at the moment when a timing marker 310 overlaps the substantial center of the input accepting frame 320a. On the other hand, as illustrated in the lower row of FIG. 10, a failure is detected when a touch is made at any moment when the timing marker 310 is deviated from the center of the input accepting frame 320b. The tactile control section 33 presents a different tactile sensation in accordance with each detection that is made with respect to the particular operation.

Moreover, by designating the input accepting frames 320a and 320b as the touch regions, it becomes possible to convey to the user an intuitive feel that a timing marker 310 has or has not matched the input accepting frame 320a or 320b.

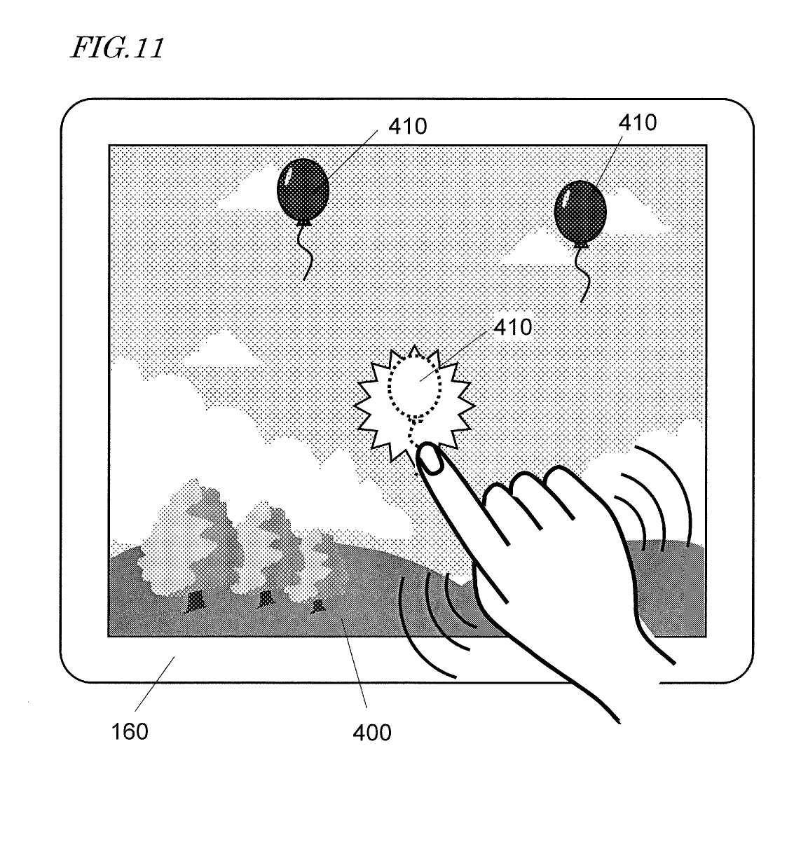

Next, FIG. 11 shows an example game program in which a touch operation is to be made on no other than markers 410 that are displayed on the display section 160.

As shown in FIG. 11, a marker displaying area 400 and moving markers 410 moving about in the marker displaying area 400 are displayed on the display section 160. As shown in FIG. 11, for example, moving markers 410 are represented as a plurality of balloons which move from the lower end to the upper end of the marker displaying area 400.

The game program of FIG. 11 is a game program where, while the moving markers 410 are being displayed in the marker displaying area 400, the moving markers 410 themselves are to be touched, thus defining the timing to make inputs.

In this case, the time (or moving velocity) that the moving markers 410 are being displayed in the marker displaying area 400 defines the reference timing being presented to the user.

As shown in FIG. 11, a success is detected when a moving marker 410 itself is touched. The tactile control section 33 presents a tactile sensation in accordance with each detection that is made with respect to the particular operation.

Moreover, by designating the moving markers 410 themselves as the touch regions, it becomes possible to convey to the user an intuitive feel that a moving marker 410 moving about in the marker displaying area 400 has or has not been touched.

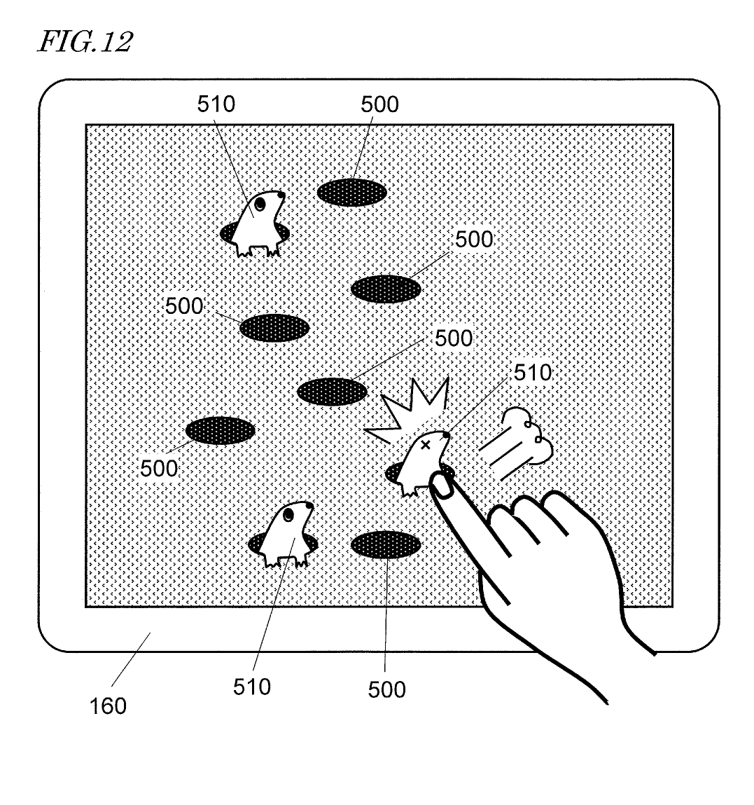

Next, FIG. 12 shows an example game program in which a touch operation is to be made with the timing that a marker indication displayed on the display section 160 changes.

As shown in FIG. 12, a plurality of marker indications 500 are displayed on the display section 160, where an object 510 may or may not be displayed at each marker indication 500. For example, the game program of FIG. 12 is a mole-whacking game, where the marker indications 500 are mole holes and the objects 510 are the moles.

The exemplary operation shown in FIG. 12 is that of a game program where one is supposed to make an input with the timing when an object becomes displayed at each marker indication 500.

In this case, the time that an object 510 is being displayed at each marker indication 500 defines the reference timing being presented to the user.

As shown in FIG. 12, a success is detected when a marker indication 500 (or an object 510) is touched at the moment when an object 510 is being displayed there. The tactile control section 33 presents a tactile sensation in accordance with each detection that is made with respect to the particular operation.

Moreover, by designating the marker indications 500 as the touch regions, it becomes possible to convey to the user an intuitive feel that an object 510 has or has not been touched at the moment when it is displayed.

Next, FIG. 13 shows an example game program in which a touch operation is to be made in accordance with the timing of a sound that is emitted from the loudspeaker section 150.

As shown in FIG. 13, keys 600 of a piano are displayed on the display section 160, and, in synchronization with an emitted sound, the displayed color of each key 600 may change to turn into a key 610, for example.

The game program of FIG. 13 is a game program where one is supposed to make an input with the timing when the color of each key 600 changes. Although the video information is similar to that in the case of FIG. 12 described above, the game program of FIG. 13 differs from that of FIG. 12 in that a position and timing to touch is indicated by sound information.

In this case, the sound data itself defines the reference timing, such that timing is being presented to the user in the form of a sound.

As shown in FIG. 13, a success is detected when a key 610 whose color has changed, based on sound information, is touched. The tactile control section 33 presents a tactile sensation in accordance with each detection that is made with respect to the particular operation.

Moreover, by designating each key 610 whose color has changed as the touch region, it becomes possible to convey to the user an intuitive feel that a correct touch operation has or has not been made in response to the timing information of a sound.

As described above, the electronic device 100 of the present embodiment utilizes piezoelectric elements for the panel vibrating section 140 to vibrate the touch panel 130, thus being able to responsively present a tactile sensation in response to a touch operation made by a user to the touch panel 130, without much delay or lingering of vibration.

In a game program which detects whether a timing of operating the touch panel 130 is good or bad in accordance with the timing of a video or sound, this makes it possible to present a tactile sensation from the touch panel 130 being touched by the user, the tactile sensation being varied in accordance with the operation timing. As a result, a novel, intuitive operation feel can be obtained.

Although the present embodiment illustrates that the predetermined range for the amount of deviation d between reference timing and input timing is defined as ±α (or ±β), this is not a limitation. A time deviation detection may be made only on the + side or the − side.

Although the present embodiment illustrates two kinds of vibration patterns to be applied in times of success, this is not a limitation. There may be one kind, or three or more kinds of, vibration pattern(s) to be applied in times of success.

Although the present embodiment illustrates that the tactile control section 33 controls the vibration pattern depending on a success or a failure, this is not a limitation. Another method of tactile sensation presentation may be to vary the intensity of vibration depending on a success or a failure.

In the present embodiment, not driving the panel vibrating section 140 at all is included as one vibration pattern. Therefore, the method of tactile sensation presentation may be to not vibrate in times of success, and to vibrate in times of failure.

Although the present embodiment illustrates a case where a touch operation to the touch panel 130 is made with a finger, this is not a limitation. So long as vibration from the touch panel 130 can be perceived as a tactile sensation, the operation may be made by way of a pen or the like.

Although the present embodiment illustrates four exemplary operations of game programs as example applications of the electronic device 100 with reference to FIG. 10 to FIG. 13, these are examples. Applications of the electronic device 100 of the present embodiment are not limited thereto.

Although there are control sections provided for controlling the respective component elements of the electronic device 100, there may be other embodiments. The microcomputer 20 may double as the various control sections, e.g., the touch panel control section 31, the displayed information control section 32, and the tactile control section 33.

### Other Embodiments

In the above, one embodiment has been described as an example of the technique disclosed in the present application. However, the technique of the present disclosure is not limited thereto, but is also applicable to other embodiments in which changes, substitutions, additions, omissions, etc., are made as necessary. Different ones of the component elements described in the above embodiment may be combined together to obtain a new embodiment.

Other embodiments will be illustrated hereinbelow.

Although the embodiment is directed to a tablet-type mobile information terminal device as an example electronic device, the electronic device is not limited thereto. For example, the electronic device may be any electronic device including a touch panel, such as a mobile phone, a PDA, a game machine, a car navigation system, an ATM, etc.

Although the above embodiment illustrates that a tactile sensation is presented by generating vibration, the technique of the present disclosure is not limited thereto. Other than vibration, tactile sensations may be presented by other methods, e.g., as a variation of friction associated with static electricity, a skin stimulation with an electric current, and a variation of the screen shape using liquid. These methods of tactile sensation presentation may be combined as necessary.

Note that the operation of the electronic device described above may be implemented in hardware or software. A computer program implementing such a control operation is stored, for example, in an internal memory or the ROM 38 of the microcomputer 20. Such a computer program may be installed onto the electronic device from a storage medium (an optical disc, a semiconductor memory, etc.) on which the computer program is recorded, or may be downloaded via a telecommunication lines such as the Internet.

### SUMMARY

The electronic device 100 according to an embodiment includes: a touch panel 130 to be touched by a user; a panel vibrating section 140 for vibrating the touch panel 130; a tactile control section 33 for controlling the panel vibrating section 140; a display section 160 for presenting reference information indicating a reference timing with which the user is to make a touch operation on the touch panel 130; and a microcomputer 20 for detecting an amount of deviation between an input timing of a touch operation made by the user on the touch panel 130 and the reference timing. Based on the detected amount of deviation, the tactile control section 33 varies the vibration of the touch panel 130 to give the user a tactile sensation through the vibration.

For example, the tactile control section 33 may vary the vibration of the touch panel 130 depending on whether the amount of deviation is large or small.

For example, the tactile control section 33 may vary the vibration of the touch panel 130 depending on whether the amount of deviation is within a first range (±α) or not.

For example, the tactile control section 33 may vary the vibration of the touch panel 130 depending on whether the amount of deviation is within a second range (±β) which is narrower than the first range (±α).

For example, based on the detected amount of deviation, the tactile control section 33 may vary at least one of the amplitude, the frequency, and the vibration period of the vibration of the touch panel 130.

For example, the reference information may include at least one of image information and sound information.

For example, the reference information may further include position information to be displayed on the display section 160; the microcomputer 20 may further detect an amount of deviation between a position at which the user has touched the touch panel 130 and a position corresponding to the position information; and, based on the amount of deviation between the touched position and the position corresponding to the position information, the tactile control section 33 may vary the vibration of the touch panel 130 to give the user a tactile sensation through the vibration.

For example, the panel vibrating section 140 may include a piezoelectric element.

For example, the touch panel 130 may be provided on a display surface of the display section 160 on which an image is to be displayed.

A computer program for causing the electronic device 100 according to an embodiment execute a vibration operation cause a computer of the electronic device 100 to execute: a step of presenting reference information indicating a reference timing with which a user is to make a touch operation on the touch panel 130; a step of detecting an amount of deviation between an input timing of a touch operation made by the user on the touch panel 130 and the reference timing; and a step of, based on the detected amount of deviation, varying the vibration of the touch panel 130 to give the user a tactile sensation through the vibration.

Embodiments have been described above as an illustration of the technique of the present disclosure. The accompanying drawings and the detailed description are provided for this purpose. Thus, elements appearing in the accompanying drawings and the detailed description include not only those that are essential to solving the technical problems set forth herein, but also those that are not essential to solving the technical problems but are merely used to illustrate the technique disclosed herein. Therefore, those non-essential elements should not immediately be taken as being essential for the reason that they appear in the accompanying drawings and/or in the detailed description.

The embodiments above are for illustrating the technique disclosed herein, and various changes, substitutions, additions, omissions, etc., can be made without departing from the scope defined by the claims and the equivalents thereof.

The present disclosure is suitable for electronic devices which generate vibration in accordance with a touch operation made by a user.

While the present invention has been described with respect to exemplary embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. An electronic device comprising:
a panel to be touched by a user;
a vibrating section for vibrating the panel;
a vibration control section for controlling the vibrating section;
a presentation section for presenting reference information indicating a reference timing with which the user is to make a touch operation on the panel; and
a detection section for detecting an amount of deviation between an input timing of a touch operation made by the user on the panel and the reference timing,
wherein,
the vibration control section varies the vibration of the panel based on the detected amount of deviation to give the user a tactile sensation through the vibration.

2. The electronic device of claim 1, wherein the vibration control section varies the vibration of the panel depending on whether the amount of deviation is large or small.

3. The electronic device of claim 1, wherein the vibration control section varies the vibration of the panel depending on whether the amount of deviation is within a first range or not.

4. The electronic device of claim 3, wherein the vibration control section varies the vibration of the panel depending on whether the amount of deviation is within a second range which is narrower than the first range.

5. The electronic device of claim 1, wherein, based on the detected amount of deviation, the vibration control section varies at least one of an amplitude, a frequency, and a vibration period of the vibration of the panel.

6. The electronic device of claim 1, wherein the reference information includes at least one of image information and sound information.

7. The electronic device of claim 1, wherein,
the reference information further includes position information to be displayed on the presentation section;
the detection section further detects an amount of deviation between a position at which the user has touched the panel and a position corresponding to the position information; and
based on the detected amount of deviation between the touched position and the position corresponding to the position information, the vibration control section varies the vibration of the panel to give the user a tactile sensation through the vibration.

8. The electronic device of claim 1, wherein the vibrating section includes a piezoelectric element.

9. The electronic device of claim 1, wherein the panel is provided on a display surface of the presentation section on which an image is to be displayed.

10. A computer program for causing an electronic device to execute a vibration operation,
the computer program causing a computer of the electronic device to execute:
a step of presenting reference information indicating a reference timing with which a user is to make a touch operation on the panel;
a step of detecting an amount of deviation between an input timing of a touch operation made by the user on the panel and the reference timing; and
a step of, based on the detected amount of deviation, varying the vibration of the panel to give the user a tactile sensation through the vibration.
